(19) United States
(12) Patent Application Publication
(10) Pub. No.: US 2010/0077324 A1
(43) Pub. Date: Mar. 25, 2010

(54) PLUGGABLE PRESENTATION AND DOMAIN COUPLING

(75) Inventors: Paul Harrington, Seattle, WA (US); Alin Constatin, Bellevue, WA (US); Matthew Johnson, Kirkland, WA (US); Jean-Pierre Duplessis, Redmond, WA (US); C. Douglas Hodges, Sammamish, WA (US); Jeffrey David Robison, Redmond, WA (US); Christopher James McGuire, Monroe, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/235,714

(22) Filed: Sep. 23, 2008

(51) Int. Cl. G06F 3/01

(52) U.S. Cl. 715/762

(57) ABSTRACT

User interface functionality in a presentation layer is coupled with data and data processing functionality of an application in a domain-specific layer. A UI-element-factory-registrar supports registration of a UI-element-factory with the domain-specific layer for invoking a UI-element to create a UI-element object. The UI-element object is bound to a domain-specific data-source object. The presentation layer may be asynchronously notified of changes in the data-source object. Data-converter objects may be provided to convert between data formats, e.g., from a native code domain-specific layer format to a managed code presentation layer format.

### BACKGROUND

Many computer systems can be viewed generally as having four major levels, namely, a hardware level at the bottom, a kernel level on top of the hardware, an application or problem-domain level on top of the kernel, and a user interface (“UI”) between the application level and users. Computer system users, whether human or otherwise, are at the top of the hierarchy. Individual components of a given computer system may be viewed as belonging to one or more of these four major levels. Processors and memory, for instance, are hardware level components which can also be configured and/or otherwise used by each of the three higher levels. Similarly, displays and keyboards transfer information between users and applications using hardware and kernel routines. In some cases, an application is closely and intricately interwoven with a user interface, to the extent that substituting a different user interface would require rewriting or at least carefully reviewing most of the application's source code.

Some applications run in managed code environments. A managed code environment provides a virtual machine between the application and the computer system hardware. By contrast, some applications are written in native code which includes instructions compiled to run directly on a particular processor. Managed code environments may provide security, portability, along with debugging and other development tools not available in some native code environments. However, native code generally runs faster than managed code, and generally uses less memory.

### SUMMARY

User interface functionality in a presentation layer is coupled in a pluggable manner with data and data processing functionality of an application in a domain-specific layer. In some embodiments, a UI-element-factory-registrar supports registration of a UI-element-factory with the domain-specific layer, for on-demand creation of a UI-element object. The UI-element object is bound to a domain-specific data-source object. In some cases, a UI-element object binds a managed code presentation-element to a native code data-source object. In some cases, the presentation layer is asynchronously notified of changes in the data-source object. In some cases, data-converter objects convert between data formats, e.g., from a native code domain-specific layer format to a managed code presentation layer format.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having a memory configured with data and instructions providing functionality for applications and their user interfaces, and also illustrating configured storage medium embodiments;

FIG. 2 is a block diagram illustrating a computer system in which data and instructions reside in part within a domain-specific layer and in part within a presentation layer;

FIG. 3 is a block diagram further illustrating and expanding an instance of the FIG. 2 computer system utilizing a Microsoft Visual Studio® platform;

FIG. 4 is a block diagram further illustrating and expanding the computer system example of FIG. 3, with particular attention to a UI factory;

FIG. 5 is a block diagram further illustrating and expanding the computer system example of FIG. 3, with particular attention to use of multiple window managers;

FIG. 6 is a block diagram further illustrating and expanding the computer system example of FIG. 3, with particular attention to data source wrapping;

FIG. 7 is a block diagram illustrating a computer system example, with particular attention to a Microsoft Windows® environment;

FIG. 8 is a block diagram further illustrating and generalizing the computer system of FIG. 2; and

FIG. 9 is a flow chart illustrating steps of some method and configured storage medium embodiments.

### DETAILED DESCRIPTION

Overview

An extensible platform such as the Microsoft Visual Studio® platform may support many co-operating extensions. Each of the extensions may be written in managed code or in native code. Some extensions may contain both managed and native pieces.

Sometimes an extension developer would like to take advantage of recent presentation technologies, such as Microsoft Windows Presentation Foundation (“WPF”) technology, when creating the extension's user interface. However, in some cases an extension includes an existing body of native code. It was not immediately clear how to add a WPF user interface to native code, because WPF is accessible only from managed code. For extensions that include large bodies of existing native code, rewriting the entire extension in managed code may be deemed too costly. In other cases, an extension developer who is creating a new extension may wish to leave the choice of presentation technology open and flexible.

Accordingly, the question arises of how a developer can take an existing body of native code and replace its user interface with one that uses WPF. More generally, one may ask how to plug any presentation technology, either existing or yet-to-be created, into a connection with any application, either managed or native.

Under one approach, the problem of coupling a presentation technology to a domain-specific application has two parts. First, one creates pieces of the user interface, such as a window or a toolbar. Second, one connects that user interface to an underlying domain-specific model so that changes in the model are reflected in the user interface, and vice versa.

Some embodiments provided herein include three primary interfaces and their implementation. A UI factory is provided to construct component parts that can be assembled into a user interface (“UI”). A native data source is provided for constructing data models in native code. A data source wrapper is provided for converting the native data source components into a form that is consumable by managed code. These three pieces can be used together to pluggably couple a presentation technology to a domain-specific application.

Many examples provided herein discuss a WPF presentation technology, but not all embodiments are limited to WPF. A presentation-neutral approach can also be used with other current or future presentation technologies, including without limit environments from Linux, Java, or Eclipse (marks of their respective owners). First, one defines a domain data source with presentation-neutral characteristics. Second, one adapts (wraps) that data source into a form which may be accessed by the chosen presentation technology. Third, one constructs user interface elements in a presentation-specific way and binds those elements to the presentation-specific wrappers. In some embodiments, the wrappers, while specific to each presentation-technology in implementation, have general purpose interfaces which work with any presentation-neutral data source.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Code” means processor instructions, data (which includes data structures), or both instructions and data. Processor instructions may be executable, interpretable, or a mixture.

“Managed code” means code which runs on a virtual machine or in a sandbox. Some examples of managed code include software written to run on the Microsoft .Net Framework (mark of Microsoft Corporation), and Java® byte code (mark of Sun Microsystems, Inc.).

“Native code” means code that runs directly on a given processor, and is used in contrast with “managed code”. Native code is sometimes called “unmanaged code”.

An “extensible platform” is a software application which allows many additional software pieces to run co-operatively, sharing functionality from the platform and communicating with the platform and, possibly, with each other. For example, the Microsoft Visual Studio® platform is an extensible platform.

A “presentation technology” is a software framework used for creating user interfaces, e.g., on a display device. Presentation technology in general includes visual, audio, command line, markup language, and other forms of interaction between applications and users. Presentation technology includes graphical user interface (“GUI”) technology but is not limited to GUI technology. Many presentation technologies exist, including for example Microsoft Windows Presentation Foundation technology, Microsoft Windows Forms technology, the Tk framework, the GTK+ toolkit, and other GUI builder tools and environments.

Throughout this document, use of the optional plural “(s)” means that one or more of the indicated feature is present. For example, “object(s)” means “one or more objects” or equivalently “at least one object”.

Similar terms may be used to describe variations on a given item. For example, “data source”, “data-source”, “DataSource”, and “DATASOURCE” each refer to a data source in a domain layer, as discussed below in various examples. The variation in terminology may reflect differences in generality, in that hyphenated terms are not necessarily tied to a particular platform or presentation technology. The variation in terminology may also reflect differences in the origin of a term, such as the difference between terms used in source code and terms used in a more general discussion.

Whenever reference is made to data or instructions, it is understood that these items configure a computer-readable memory, as opposed to simply existing on paper, in a person's mind, or as a transitory signal on a wire, for example.

Operating Environments

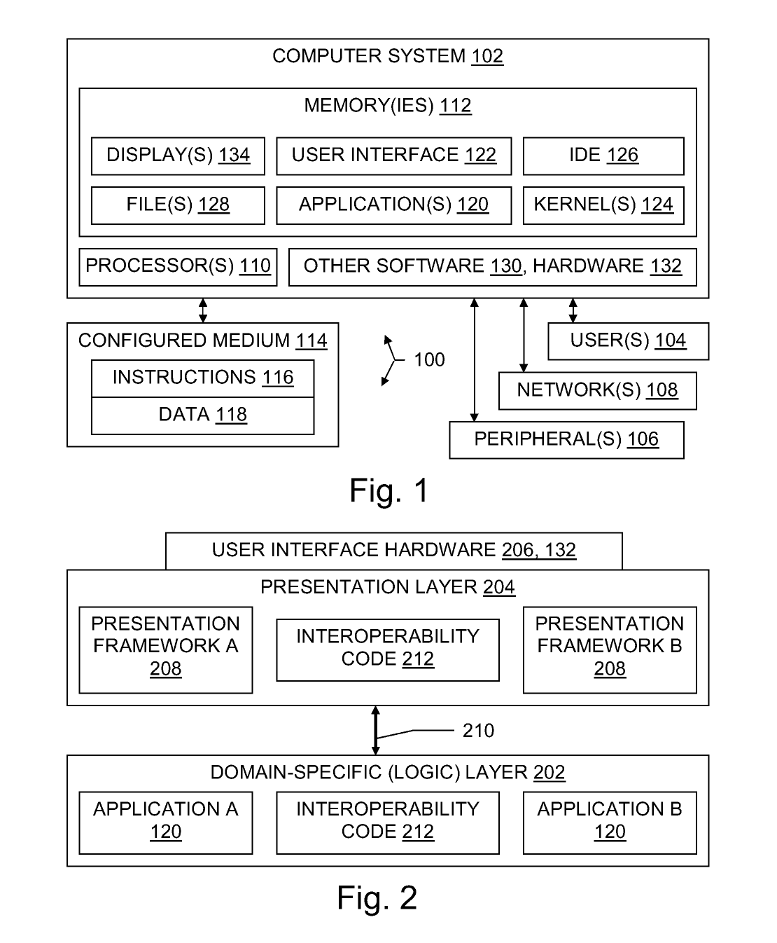

With reference to FIG. 1, an operating environment 100 for an embodiment may include a target computer system 102. The computer system 102 may be a multiprocessor computer system, or not. An operating environment may include one or more computer systems, which may be clustered, client-server networked, and/or peer-to-peer networked. Some operating environments include a stand-alone (non-networked) computer system.

Human users 104 may interact with the computer system 102 by using displays 134, keyboards, and other peripherals 106. A system administrator is understood to be a particular type of user 104; end-users are also considered users 104. Storage devices and/or networking devices may be considered peripheral equipment in some embodiments. Other computer systems (not shown) may interact with the computer system 102 or with another system embodiment using one or more connections to a network 108 via network interface equipment, for example. Hardware such as buses between processors and memory, a power supply, timer circuits, and the like are not shown but would be present in many if not all systems 102.

The computer system 102 includes at least one logical processor 110. The computer system 102, like other suitable systems, also includes one or more memories 112. The memories 112 may be volatile, non-volatile, fixed in place, removable, magnetic, optical, and/or of other types. In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a memory 112. Other examples of memory 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the memory 112/medium 114 in which they reside; when that memory is a functional part of a given computer system, the instructions 116 and data 118 also configure that computer system. Memories 112 may be of different physical types. Applications 120, user interfaces 122, a kernel 124, and other items shown in the Figures may reside partially or entirely within one or more memories 112, thereby configuring those memories.

In a given operating environment 100, whether within an Integrated Development Environment (IDE) 126 or otherwise, a current configuration of application and system software, files 128, registry entries, and other components will be present. The current configuration of installed components provides a given user with particular functionality(ies). That user 104 may receive different functionality(ies) if the configuration changes and/or if the user logs in under a different user account. Other software 130 and other hardware 132 than that already enumerated may also be present.

The illustrated configuration includes an Integrated Development Environment 126 which provides a developer with a set of coordinated software development tools. In particular, some of the suitable operating environments for some embodiments include or help create a Microsoft® Visual Studio® development environment (marks of Microsoft Corporation) configured to support source code development according to the teachings herein. Some suitable operating environments include Java® environments (mark of Sun Microsystems, Inc.), and some include environments which utilize languages such as C++ or C# (“C-Sharp”). However, teachings herein are applicable with a wide variety of programming languages, programming models, and programs.

Systems

FIGS. 2 through 8 illustrate several examples, at various levels of detail. Different aspects of these examples may be included in a given embodiment, and different aspects may also be excluded. A given embodiment may be informed by an example without fully matching the example in every aspect. Likewise, a given embodiment may draw different aspects from different examples.

FIG. 2 shows an example of a “separated presentation” architecture. Separated presentation architectures may also be referred to loosely in the art as “model, view, presenter” or “model, view, controller” architectures. In the particular approach shown in FIG. 2, a domain-specific layer 202 includes data and data processing functionality specific to a problem domain. The problem domain could be any of a wide variety of domains, from medical data processing to commercial transaction management, to some other type of database management or data processing, for example. The domain-specific layer 202 may also be referred to as the logic layer, or the business logic layer. Data processing code for one or more application programs resides in the domain-specific layer 202.

The architectural approach shown in FIG. 2 also includes a presentation layer 204, which may in general be native or managed. The presentation layer provides user interface functionality through displays 134 and other user interface hardware 206. Peripherals 106 such as human user I/O devices (screen, keyboard, mouse, microphone, speaker, motion sensor, other user interface hardware 206) may be present in operable communication with one or more processors 110 and memory 112. The user interface hardware 206 is controlled at least in part by code within one or more presentation frameworks 208, which include presentation technology.

Commands, selections, values, and other data input by a user 104 through user interface hardware 206 may be communicated 210 from the presentation layer 204 to the domain-specific layer 202 for processing within an application 120. Similarly, values, selectable items, reports, and other data produced by an application 120 may be communicated 210 from the domain-specific layer 202 to the presentation layer 204 for presentation to users 104 through user interface hardware 206.

In some embodiments, communications 210 in either direction between domain-specific layer 202 and presentation layer 204 are provided by particular steps and items discussed in detail herein. In particular, communications 210 are accomplished using interoperability code 212 mechanisms discussed herein.

Separating the domain-specific layer 202 and the presentation layer 204 allows legacy native applications 120 to evolve to a more modern data binding model, with a presentation layer capable of fetching data whenever the user interface is ready. The presentation layer can listen for notification communications 210 from the domain-specific layer. The domain-specific layer can also be freed to collect data at its own rhythm and to notify the presentation layer when new data or updated data becomes available. The architecture shown in FIG. 2 facilitates migration from a native (blocking, single UI threading model) to a model allowing a developer to opt in using asynchronous notifications.

In some embodiments, networking interface equipment provides access to networks 108, using components such as a packet-switched network interface card, a wireless transceiver, or a telephone network interface, for example, will be present in the computer system. However, an embodiment may also communicate through direct memory access, removable nonvolatile media, or other information storage-retrieval and/or transmission approaches, or an embodiment in a computer system may operate without communicating with other computer systems.

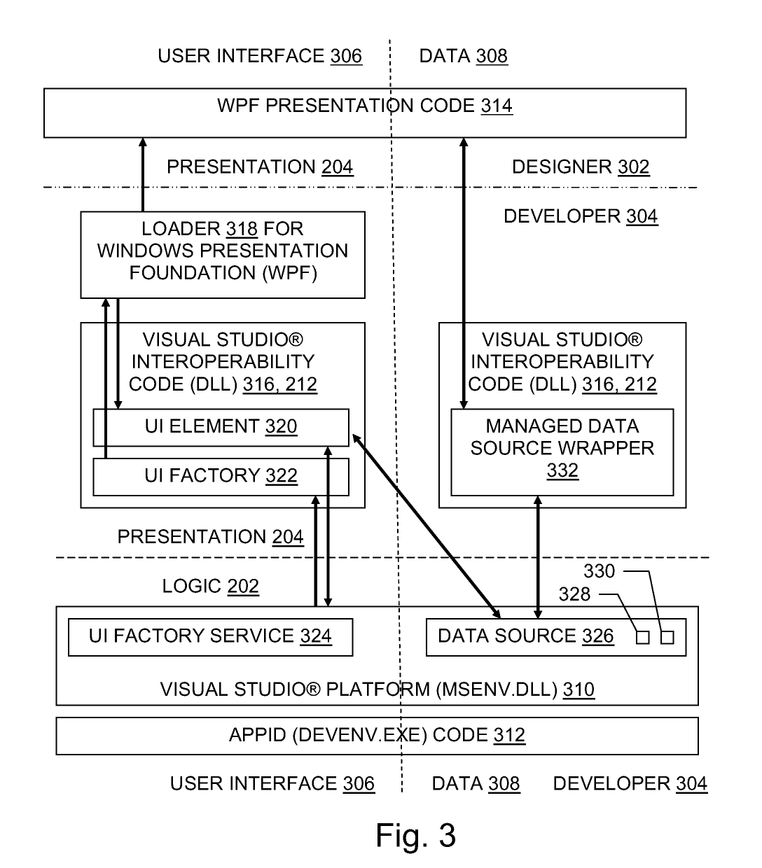

FIG. 3 shows an example of a system architecture which builds on and expands the example of FIG. 2. As in FIG. 2, the architecture shown in FIG. 3 includes a logic layer 202 and a presentation layer 204, which are separated in FIG. 3 by a horizontal dashed line. FIG. 3 also shows a possible division of job responsibilities between a designer 302 and a developer 304, as context for the embodiment. A vertical dashed line in FIG. 3 also divides code which primarily provides user interface 306 functionality and code which primarily provides domain-specific data 308 handling functionality.

The example shown in FIG. 3 includes a Microsoft Visual Studio® platform 310. An application having an AppID code 312 includes an executable that calls a main DLL of the Visual Studio® platform 310. The Visual Studio® platform 310 includes a DLL msenv.dll, which the application executable loads and runs. The application executable includes devenv.exe for Visual Studio®, and similar executable DLLs are available for other Microsoft tools, such as C# Express, Visual Basic Express, C++ Express, and so on.

The FIG. 3 example also includes Microsoft Windows Presentation Foundation (WPF) code 314, which supplies user interface items such as windows, toolbars, and so on. Other embodiments utilize other presentation layers, such as Sun Microsystems Java® environment Java Swing technology, Microsoft Windows Forms technology, the native Microsoft Windows® graphic user interface (often referred to as Win32), or HTML for Web-based applications, for example. More generally, the presentation layer need not always be video-based; for visually impaired users, a presentation layer could operate through a Braille output device with tactile response and/or a speech synthesizer.

In the FIG. 3 example, communication between the WPF code 314 and the platform 310/application code 312 occurs by way of interoperability code 316 and a loader 318. In the illustration and elsewhere herein, “UI” refers to “user interface”.

In a Gel framework that provides examples of items shown in FIG. 3, the loader 318 is defined using the following:

```
        // The WPF loader interface is implemented by the
ILocalRegistry-creatable object CLSID_VsUIWpfLoader
interface IVsUIWpfLoader : IUnknown
{
    // Create a visual element given its fully-qualified
type name
    // If the element's assembly is in the GAC or on the
probing path, the codeBase doesn't need to be specified
    HRESULT CreateUIElement( [in] LPCWSTR elementFQN, [in]
LPCWSTR codeBase, [out] IVsUIElement** ppUIElement );
    // Create a visual element given its managed type
    // To be used from managed code, allows specifying
directly the System.Type of the element
    HRESULT CreateUIElementOfType( [in] IUnknown *
pUnkElementType, [out] IVsUIElement** ppUIElement );
};
```

“Gel” is a name used internally at Microsoft to identify a framework including Visual Studio® user shell interfaces whose names begin with “IVsUI”. The Gel framework illustrates aspects of interoperability code 316. The Gel framework supports pluggable coupling, in that it allows UI testing outside the Visual Studio® platform, and allows testing of business logic code apart from UI effects by mocking or replacing the UI.

The illustrated interoperability code 316 includes one or more UI elements 320. Every piece of a user interface that can be created with the invention is called a UI element. Consistent with the FIG. 3 example, one UI element 320 implements an IVsUIElement interface such as the following from the Gel framework:

```
        // Any IVsUIElement can also implement
IObjectWithSite, and the factories will site the object with
a service provider.
interface IVsUIElement : IUnknown
{
    // Get the data source on this element
    HRESULT get_DataSource([out] IVsUISimpleDataSource**
ppDataSource);
    // Bind the given data source to this element
    HRESULT put_DataSource([in] IVsUISimpleDataSource*
pDataSource);
    // Accelerator translations (used for modeless UI)
    HRESULT TranslateAccelerator( [in] IVsUIAccelerator*
pAccel );
    // Get access to the implementation-specific object
(e.g. IVsUIWpfElement, IVsUIWin32Element)
    HRESULT GetUIObject( [out] IUnknown** ppUnk );
};
```

The interoperability code 316 also includes one or more UI factories 322. UI elements 320 are created by UI factories 322. In the example of FIG. 3, UI factories are declared in a Microsoft Windows® registry and are uniquely identified by a globally unique identifier (GUID). The UI-element object identifier may be unique within the computer system, or it may be unique within the current runtime environment for a task, including all tasks that communicate with the task or share data with the task. The identifier is used by the UI factory registrar to locate an appropriate UI factory, and by clients of the system to request a specific UI element. One UI factory implements an IVsUIFactory interface, such as the following example from the Gel framework:

```
        // Implemented by packages that supply their own UI
factories.
// Also implemented by the shell as the SVsUIFactory
service.
// Register your UI factory under the UIProviders subkey in
the registry.
// Each factory must be supplied by a package. The package
must call
// IVsRegisterUIFactories::RegisterUIFactory in their
SetSite call.
interface IVsUIFactory : IUnknown
{
    // Create an instance of the given element
    HRESULT CreateUIElement( [in] REFGUID guid, [in] DWORD
dw, [out] IVsUIElement** ppUIElement );
};
```

A UI factory 322 allows creation on demand of its supported UI element(s) 320. In the example of FIG. 3, each UI element creatable by a UI factory is identified by a 32-bit number (DWORD), unique within that UI factory implementation. Thus, every UI element creatable by the system shown in FIG. 3 is uniquely identified by a (GUID:DWORD) pair.

The interoperability code 316 also includes one or more UI factory services 324. In the FIG. 3 example, the UI factories 322 are required to be registered at runtime with a global factory in the extensible platform 310. A global UI factory in the form of a UI factory service 324 provides management services for the individual UI factories 322, loading on demand the packages implementing these factories. The UI factory service 324 provides code with single entry point to use when a new UI element 320 needs to be created. One UI factory service 324 of the FIG. 3 example implements IVsRegisterUIFactories and can be obtained via query interface from the SVsUIFactories service, consistent with the following from the Gel framework:

```
        // The UI factory registrar is implemented by the
SVsUIFactories service
interface IVsRegisterUIFactories : IVsUIFactory
{
    // Register this UI factory with the global service
    HRESULT RegisterUIFactory( [in] REFGUID guid, [in]
IVsUIFactory* pUIFactory );
};
```

The example of FIG. 3 also includes a data source 326. A UI element 320 provides a presentation layer 204 for data organized in a hierarchical data model. The data source 326 represents this data model. In one example consistent with FIG. 3, a data source is an object implementing an IVsUIDataSource interface such as the following from the Gel framework:

```
        // Common functionality for all data sources:
command/verb handling
interface IVsUIDispatch : IUnknown
{
    // Invoke the given verb
    HRESULT Invoke( [in] LPCOLESTR verb, [in] VARIANT pvaIn,
[out] VARIANT* pvaOut );
    // Discover all available verbs
    HRESULT EnumVerbs( [out] IVsUIEnumDataSourceVerbs**
ppEnum );
// Base interface for all element's data sources
(IVsUIDataSource, IVsUICollection, and
IVsUIDynamicCollection)
interface IVsUISimpleDataSource : IVsUIDispatch
{
    // Closes the data source - events sinks will be
disconnected (if data source supports events), data source
items or properties will be closed, too, etc.
    HRESULT Close( );
};
// Interface representing a Gel data source.
// It inherits from IVsUISimpleDataSource
// A Gel Data source contains a collection of named
properties
interface IVsUIDataSource : IVsUISimpleDataSource
{
    // Retrieve the value of the given named property
    HRESULT GetValue( [in] LPCOLESTR prop, [out] IVsUIObject
** ppValue );
    // Modify the value of the given named property
    HRESULT SetValue( [in] LPCOLESTR prop, [in] IVsUIObject
* pValue );
    // Register for property change notification
    HRESULT AdvisePropertyChangeEvents( [in]
IVsUIDataSourcePropertyChangeEvents* pAdvise, [out]
VSCOOKIE* pCookie );
    // Unregister from property change notification
    HRESULT UnadvisePropertyChangeEvents( [in] VSCOOKIE
cookie );
    // Obtain an enumerator for all the named properties
    HRESULT EnumProperties( [out]
IVsUIEnumDataSourceProperties** ppEnum );
};
```

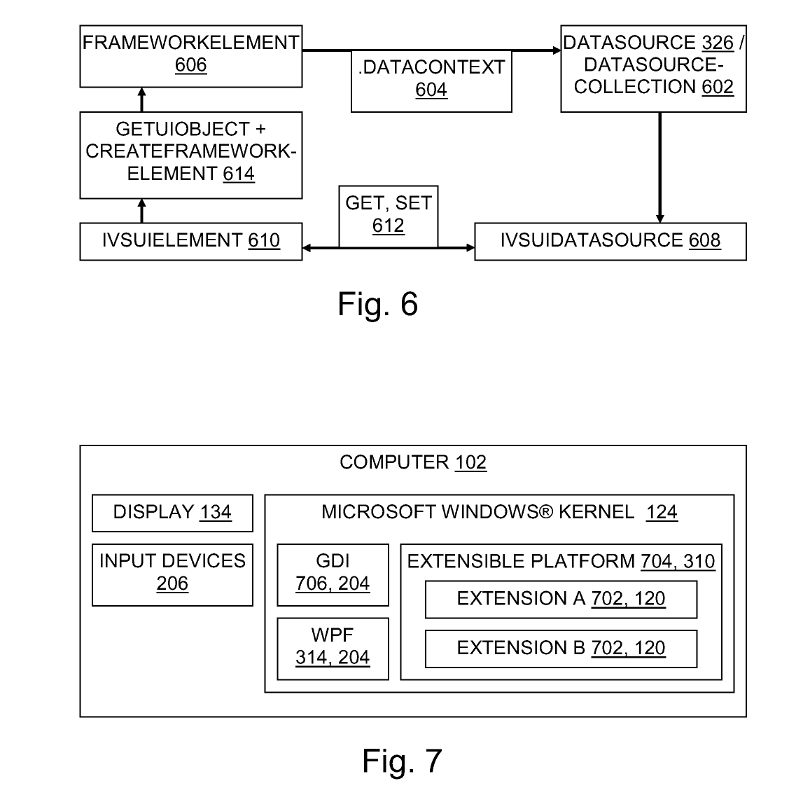

Conceptually or otherwise related data sources 326 may be organized into collections. For clarity of illustration, FIG. 3 does not expressly show such collections, but they may be present. FIG. 6 expressly shows a data source collection 602. In the examples of FIG. 3 and FIG. 6, a data source collection 602 includes an object implementing an IVsUICollection interface or an IVsUIDynamicCollection interfaces, such as the following from the Gel framework:

```
        // Interface which represents a homogenous
collection of data sources
interface IVsUICollection : IVsUISimpleDataSource
{
    // Get the count of elements in the collection
    HRESULT get_Count( [out] UINT* pnCount );
    // Get the nItem-th element. Items are zero-based.
    HRESULT GetItem( [in] UINT nItem, [out] IVsUIDataSource
**pVsUIDataSource);
};
// Interface which represents a modifiable collection
interface IVsUIDynamicCollection : IVsUICollection
{
    // Add an item to the end of the collection. On success,
pIndex contains
    // the zero-based index of the newly added item
    HRESULT AddItem( [in] IVsUIDataSource* pItem, [out]
UINT* pIndex );
    // Insert an item at the given position in the
collection
    HRESULT InsertItem( [in] UINT nIndex, [in]
IVsUIDataSource* pItem );
    // Remove an item from the collection
    HRESULT RemoveItem( [in] UINT nIndex );
    // Modify an item in the collection
    HRESULT ReplaceItem( [in] UINT nIndex, [in]
IVsUIDataSource* pItem );
```

In the examples of FIGS. 3 and 6, a data source collection 602 (whether dynamic or not) is a list of data source 326 elements that can be used for property bindings in listviews, listboxes, or wherever a collection is required. The collected data source 326 elements would usually have the same properties.

The Gel framework includes additional interfaces such as IVsDataSourceFactory and IVsRegisterDataSourceFactories which support creating data sources with pre-defined schemas (name and type of properties) that are suitable for use with specific UI elements:

```
        // Implemented by packages that supply their own
DataSource factories.
// Also implemented by the shell as the SVsDataSourceFactory
service.
// Register your DataSource factory under the
DataSourceProviders subkey in the registry.
// Each factory must be supplied by a package. The package
must call
// IVsRegisterDataSourceFactories::RegisterDataSourceFactory
in their SetSite call.
interface IVsDataSourceFactory : IUnknown
{
    // Return the given data source (singleton)
    HRESULT GetDataSource( [in] REFGUID guid, [in] DWORD dw,
[out] IVsUIDataSource** ppUIDataSource );
};
// The DataSource factory registrar is implemented by the
SVsDataSourceFactories service
// Derives from IVsDataSourceFactory
interface IVsRegisterDataSourceFactories :
IVsDataSourceFactory
{
    // Register this DataSource factory with the global
service
    HRESULT RegisterDataSourceFactory( [in] REFGUID guid,
[in] IVsDataSourceFactory* pDataSourceFactory );
};
```

More generally, data sources 326 contain properties 328 and verbs 330. Properties 328 are used for passing data between the logic layer 202 and the presentation layer 204. In the FIG. 3 example, each property 328 is identified by its name, which is implemented as a string. Each property 328 also has a well defined type, such as “VsUI.Int32” or “VsUI.ImageList”. Each property 328 also has one or more values that can be empty, be directly set, or fallback to use another property's value. Whenever a property changes value, an event may be fired to any registered listeners. Usually properties are modified by the code that displays the UI element 320, and the UI 306 subscribes to these events, so the UI can be updated to reflect changes in the data model. In the Gel framework, properties are defined using the following:

```
        // Represents a property in a Gel data source.
Implemented by clients.
interface IVsUIDataSourceProperty : IUnknown
{
    // Get the name of the property
    HRESULT get_Name( [out] BSTR* pName );
    // Get the logical type of the property
    HRESULT get_Type( [out] BSTR* pTypeName );
};
// Enumeration of data source properties (see IEnumXXXX)
interface IVsUIEnumDataSourceProperties : IUnknown
{
    // Retrieves a specified number of items in the
enumeration sequence.
    HRESULT Next([in] ULONG celt, [out, size_is(celt),
length_is(*pceltFetched)] IVsUIDataSourceProperty **rgelt,
[out] ULONG *pceltFetched);
    // Skips over a specified number of items in the
enumeration sequence.
    HRESULT Skip([in] ULONG celt);
    // Resets the enumeration sequence to the beginning.
    HRESULT Reset(void);
    // Creates another enumerator that contains the same
enumeration state as the current one.
    HRESULT Clone([out] IVsUIEnumDataSourceProperties
**ppEnum);
};
```

A verb is a named action, similar to a command, that can be associated with a data source. A verb may give both sides (e.g., native and managed) a consistent way to invoke the action. In the FIG. 3 example, each verb 330 serves to execute code in the logic layer 202 as a result of user action(s) in the presentation layer 204. For instance, verb 330 callback handlers are called when a user 104 presses a button in a dialog or otherwise interacts with the presentation code 314. Like properties 328, verbs 330 are identified by their name (a string). In the Gel framework, verbs are defined using the following:

```
        // Enumeration of verbs in a data source (see
IEnumXXXX)
interface IVsUIEnumDataSourceVerbs : IUnknown
{
    // Retrieves a specified number of items in the
enumeration sequence.
    HRESULT Next([in] ULONG celt, [out, size_is(celt),
length_is(*pceltFetched)] BSTR *rgelt, [out] ULONG
*pceltFetched);
    // Skips over a specified number of items in the
enumeration sequence.
    HRESULT Skip([in] ULONG celt);
    // Resets the enumeration sequence to the beginning.
    HRESULT Reset (void);
    // Creates another enumerator that contains the same
enumeration state as the current one.
    HRESULT Clone ([out] IVsUIEnumDataSourceVerbs **ppEnum);
};
```

Managed data source wrapper(s) 332 wrap native code data source(s) 326 to make their data accessible in a managed code environment.

With regard to property 328 values, in the FIG. 3 example properties in a data source 326 are objects that implement an IVsUIObject interface; IVsUIObjects may serve as wrappers 332. This definition is from the Gel framework:

```
    // The interface that is implemented by any data
value exchanged via Gel interfaces between the presentation
and logic layer
interface IVsUIObject : IUnknown
{
  // Get the logical type of this object
  HRESULT get_Type( [out] BSTR * pTypeName );
  // Get the format of this object. This format and the
(logical) type together
  // form the “physical type” of this object. Ojects may
be converted to
  // objects of the same logical type but different
formats via data converters.
  HRESULT get_Format( [out] VSUIDATAFORMAT * pdwDataFormat
);
  // Get the value of this object as a VARIANT. The
variant type depends on
  // the physical type.
  HRESULT get_Data( [out] VARIANT * pVar );
  // Compare this object with another
  HRESULT Equals( [in] IVsUIObject * pOtherObject, [out]
VARIANT_BOOL * pfAreEqual );
};
```

In the FIG. 3 example, property values reside in one of two categories: built-in property values, and custom property values. Built-in property values can be simple types, an empty value, or data source(s). Simple types like bool, char, int, string (VsUI.Boolean, VsUI.Char, VsUI.Int32, VsUI.String, etc) don't require data conversion when they are passed between various technologies; their data is stored as variants, and the system can do automatic conversion between native/managed code boundaries. Empty values are used for fallback properties. Data sources 326 and data source collections 602 serve as nodes in the hierarchical data model. Values of more complex types are implemented as custom properties.

Custom properties require conversion when they are passed between various technologies (WPF, Win32, WinForms, etc). For instance, a property of type VsUI.ImageList can be seen in Win32 code as HIMAGELIST, in Microsoft .NET environment code as System.Drawing.ImageList, and in WPF code as an observable IList<ImageSource>. Custom property values have a format, VSUIDATAFORMAT, which is specific to either the logic or presentation code that set them. In the Gel framework, VSUIDATAFORMAT is defined as follows:

// (not bitflags)
typedef enum _tagVSUIDATAFORMAT
{

| | |
|---|---|
| VSDF_BUILTIN | = 0, |
| VSDF_WIN32 | = 1, |
| VSDF_WINFORMS | = 2, |
| VSDF_WPF | = 3, |

} _VSUIDATAFORMAT;
// extensible to other presentation technologies via
// additional enumeration values
typedef DWORD VSUIDATAFORMAT;
// A list of supported built-in types

| | |
|---|---|
| cpp_quote(“#define VSUI_TYPE_CHAR | L\”VsUI.Char\“”) |
| // I8 | |
| cpp_quote(“#define VSUI_TYPE_INT16 | L\”VsUI.Int16\“”) |
| // I16 | |
| cpp_quote(“#define VSUI_TYPE_INT32 | L\”VsUI.Int32\“”) |
| // I32 | |
| cpp_quote(“#define VSUI_TYPE_INT64 | L\”VsUI.Int64\“”) |
| // I64 | |
| cpp_quote(“#define VSUI_TYPE_BYTE | L\”VsUI.Byte\“”) |
| // UI8 | |
| cpp_quote(“#define VSUI_TYPE_WORD | L\”VsUI.Word\“”) |
| // UI16 | |
| cpp_quote(“#define VSUI_TYPE_DWORD | L\”VsUI.DWord\“”) |
| // UI32 | |
| cpp_quote(“#define VSUI_TYPE_QWORD | L\”VsUI.QWord\“”) |
| // UI64 | |
| cpp_quote(“#define VSUI_TYPE_BOOL | L\”VsUI.Boolean\“”) |
| // BOOL | |
| cpp_quote(“#define VSUI_TYPE_STRING | L\”VsUI.String\“”) |
| // BSTR | |
| cpp_quote(“#define VSUI_TYPE_DATETIME | |

| | |
|---|---|
| L\”VsUI.DateTime\“”) | // DATETIME |

| | |
|---|---|
| cpp_quote(“#define VSUI_TYPE_SINGLE | L\”VsUI.Single\“”) |
| // R4 | |
| cpp_quote(“#define VSUI_TYPE_DOUBLE | L\”VsUI.Double\“”) |
| // R8 | |
| cpp_quote(“#define VSUI_TYPE_DECIMAL | L\”VsUI.Decimal\“”) |
| // DECIMAL | |

cpp_quote(“#define VSUI_TYPE_DATASOURCE

| | |
|---|---|
| L\”VsUI.DataSource\“”) | // DataSource |

cpp_quote(“#define VSUI_TYPE_COLLECTION

| | |
|---|---|
| L\”VsUI.Collection\“”) | // DataSource collection |

// A list of other types (can be extended using data
converters)

| | |
|---|---|
| cpp_quote(“#define VSUI_TYPE_BITMAP | L\”VsUI.Bitmap\“”) |
| cpp_quote(“#define VSUI_TYPE_ICON | L\”VsUI.Icon\“”) |

cpp_quote(“#define VSUI_TYPE_IMAGELIST
L\”VsUI.ImageList\“”)

| | |
|---|---|
| cpp_quote(“#define VSUI_TYPE_COLOR | L\”VsUI.Color\“”) |
| // These defines are “logical types”, not formats | |

The VSUIDATAFORMAT data type refers to the format of the IVsUIObject (values of properties of IVsUIDataSource). Some value types (e.g. VSUI_TYPE_INT32, VSUI_TYPE_STRING) use a built-in format, and some use formats that are specific to presentation technologies (e.g., Win32, WinForms, WPF). When the presentation technology encounters data in a different format than it can natively understand and display, a format conversion is required for the uiobject; the display technology will obtain an IVsUIDataConverter from a converter manager to convert between the creation and the display format. Values with built-in format don't need this conversion because their representation is the same in all the display technologies of the system.

In the Gel framework, data formats are presented in two pieces. The combination of pieces is called the “Physical Type”. The Physical Type consists of a “Logical Type” and a “Presentation Technology”; Gel also uses the term “format” for the latter part. For example, an icon may have the Physical Type of “{Icon, Win32}” where “Icon” is the logical type (a rectangular grid of pixels used to form a pictorial representation of an action) and “Win32” is the presentation technology, or “format” of the logical type. Win32 is a native code technology (it stands for Windows 32-bit and is the native code API for the Microsoft Windows® operating system). One may want to convert this physical type, “{Icon, Win32}” into something which can be displayed using WPF, a managed technology. The WPF Physical Type for an icon would be “{Icon,WPF}”. This matches “{Icon, Win32}” in logical type, but doesn't match on format, so the system attempts to find and use a data converter object 802 for icons from Win32 to WPF.

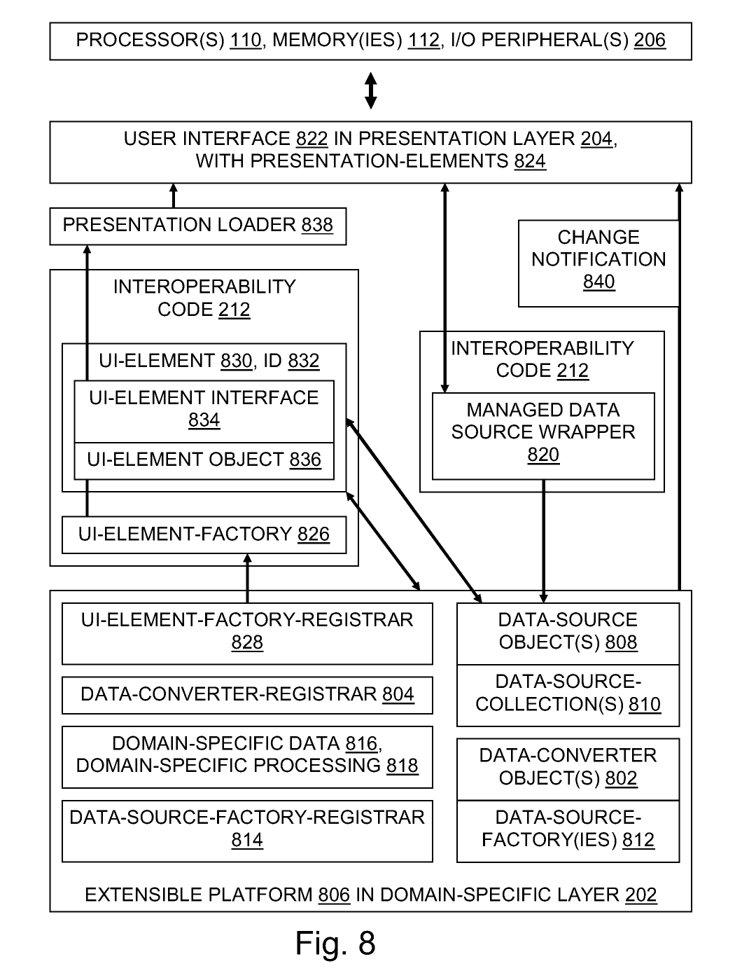

In the FIG. 3 example, and in a more general example illustrated in FIG. 8, custom property values require implementation of data converter object(s) 802, such as object(s) implementing IVsUIDataConverter along the lines of this example from the Gel framework:

```
// Packages can implement their own data converters for new
data types or new presentation technologies/formats
interface IVsUIDataConverter : IUnknown
{
    // Get the logical type to which this converter applies.
    HRESULT get_Type( [out] BSTR * pTypeName );
    // Get the ‘from’ and ‘to’ formats to which this
converter applies.
    HRESULT get_ConvertibleFormats([out] VSUIDATAFORMAT *
pdwDataFormatFrom, [out] VSUIDATAFORMAT * pdwDataFormatTo );
    // Convert an object.
    HRESULT Convert( [in] IVsUIObject * pObject, [out]
IVsUIObject ** ppConvertedObject );
};
```

Data converter objects 802 are used for converting between various formats of custom properties 328. In the examples, each data converter is identified by a GUID, declared in a kernel registry, and registered at runtime with a data converter registrar 804. In some cases, a converter can only convert values of a specific type and is unidirectional, only converting from a first format to a second format; a different converter would be used to convert from the second format to the first format.

In some cases, a data converter registrar 804, also known as a data converter manager, is an object implementing a IVsUIDataConverterManager interface, as in this example from the Gel framework:

```
// The converter manager is implemented by the shell on the
SVsUIDataConverters service, allowing packages to register
converters for additional data types
interface IVsUIDataConverterManager : IUnknown
{
    // Add a new converter for the given type
    HRESULT RegisterConverter( [in] LPCOLESTR typeName, [in]
VSUIDATAFORMAT dwDataFormatFrom, [in] VSUIDATAFORMAT
dwDataFormatTo, [in] IVsUIDataConverter * pConverter );
    // Remove a converter from the list of registered
converters
    HRESULT UnregisterConverter( [in] LPCOLESTR typeName,
[in] VSUIDATAFORMAT dwDataFormatFrom, [in]
VSUIDATAFORMAT dwDataFormatTo );
    // Retrieve a converter for the given type
    HRESULT GetConverter( [in] LPCOLESTR typeName, [in]
VSUIDATAFORMAT dwDataFormatFrom, [in] VSUIDATAFORMAT
dwDataFormatTo, [out] IVsUIDataConverter ** ppConverter);
    // Retrieve a suitable converter for the given object in
the destination format
    HRESULT GetObjectConverter( [in] IVsUIObject * pObject,
[in] VSUIDATAFORMAT dwDataFormatTo, [out] IVsUIDataConverter
** ppConverter);
};
```

A data converter registrar 804 provides management functionality for data converters, such as registration, on-demand loading of packages implementing the converters, and obtaining the appropriate converter (if available) required to convert between two specific data formats of a custom property type. In the Gel framework examples, the data converter manager can be obtained via query interface from the SID_SVsUIDataConverters service.

One version of Gel code supports only a limited set of basic properties such as int and uint that have equivalent types in both managed/native worlds. Anything more complex gets seen as VT_UNKNOWN/object and type checking cannot be enforced. The managed code can set a property with a value that cannot be understood back by the native code. Gel code also supports passing icons (HICONS wrapped in a dedicated IVSHIcon interface) from native code into managed code and seeing them as ImageSource, but to make this possible the code has high awareness of this interface and does one-way type conversion; this mechanism is not easily extensible to custom types and is also not favored because of ambiguous conversion problems.

According to a custom properties variation, a developer can work with Gel properties in a natural way across the native/managed boundaries. For instance, one would work in both native and managed code with the same “BackgroundImage” property using HBITMAPs from native code, but would use it as an ImageSource when working with it from managed code. As other examples, HBITMAP maps to System.Windows.Media.BitmapSource, HICON maps to System.Windows.Media.ImageSource, and RGB maps to System.Windows.Media.Color. In a system designed for use with Microsoft .Net 2.0 technology, a developer might also want HBITMAP mapped to System.Drawing.Bitmap, HICON mapped to System.Drawing.Icon, and RGB mapped to System.Drawing.Color. When invoking a WPF dialog from Microsoft .Net 2.0 technology, a developer might want type conversions in which System.Drawing.Bitmap maps to System.Windows.Media.BitmapSource, System.Drawing.Icon maps to System.Windows.Media.ImageSource, and System.Drawing.Color maps to System.Windows.Media.Color. If Microsoft .Net code targets a Win32 dialog box, a developer might want reverse conversions like System.Drawing.Bitmap maps to HBITMAP, System.Drawing.Icon maps to HICON, and System.Drawing.Color maps to RGB. All these mappings are unidirectional but potentially bidirectional in a variation, allowing conversion in either direction although a different data converter object 802 may be used in each direction. This duality of the properties may be transparent for the users of the properties. Also, if a property requires type conversion, a system may delay this conversion until the property is needed and its value is obtained by consuming code.

In the Gel framework, the following are some examples of interfaces used to wrap various formats:

```
        // Interface used by “VsUI.Icon” type in Win32
format to wrap HICONs (also controls lifetime).
interface IVsUIWin32Icon : IVsUIObject
{
    // Get the HICON
    HRESULT GetHICON( [out] INT_PTR* phIcon );
};
// Interface used by “VsUI.ImageList” type in Win32 format
to wrap HIMAGELISTs (also controls lifetime).
interface IVsUIWin32ImageList : IVsUIObject
{
    // Get the HIMAGELIST
    HRESULT GetHIMAGELIST( [out] INT_PTR* phImageList );
};
// Interface used by “VsUI.Bitmap” type in Win32 format to
wrap HBITMAPs (also controls lifetime).
interface IVsUIWin32Bitmap : IVsUIObject
{
    // Get the HBITMAP
    HRESULT GetHBITMAP( [out] INT_PTR* phBitmap );
    //Gets a BOOL representing whether or not the HBITMAP
offered
    //by this object contains alpha-channel information.
    HRESULT BitmapContainsAlphaInfo( [out] BOOL
*pfHasAlpha);
};
// Interface used by “VsUI.Color” type in Win32 format to
wrap RGB values
interface IVsUIWin32Color : IVsUIObject
{
    // Get the COLORREF
    HRESULT GetCOLORREF( [out] COLORREF * pColor );
};
```

In one version of the Gel framework, property values are represented as VARIANTs. However, a variant does not carry enough information necessary to distinguish a bitmap from an icon and have strong typing on the property values. In a different variation, property values are designed as objects implementing the IVsUIObject interface. Such an object has a Type (stored as a string), e.g. “VsUI.Int”, or “VsUI.String” or “VsUI.Icon”, and a Format (stored as a DWORD), identifying the presentation technology that created the property (e.g. VSDF_Win32, VSDF_Winforms, VSDF_WPF). User-provided converters convert between different formats of a type. Common properties like int and string don't require this conversion; for example, Microsoft .Net technology does the necessary type marshaling. Such properties may use a special format, BuiltIn (VSDF_Builtin), to indicate the conversion is not necessary. BuiltIn properties would have a method that allows retrieving directly the inner data.

With regard to format converter objects 802, Win32 code creates and knows how to use a property with type VsUI.Icon if it has a Win32 format (storing a HICON GDI handle). Similarly, WinForms code (MPF package) creates properties of type VsUI.Icon with the WinForms format (storing a System.Drawing.Icon). A Microsoft .Net 2.0 package using the Managed Package Framework (MPF) library creates icon properties in the VSDF_WinForm format. If that package needs to invoke the a Win32 dialog box, the icons are converted to VSDF_Win32 from which the about box can get an HICON to display the image. Similarly, WPF code for a WPF version of the same dialog box converts the icon properties to VSDF_WPF format from which the xaml code can get an ImageSource. Gel code is designed for consistency with the IVsUIDataConverter interface; converters will convert between different formats of property values of a specific type. Conversion happens in the consumption side, allowing conversion (when necessary) to be delayed until the property value is actually required. Conversion will not be performed for properties with built-in types (inner data will be directly exposed), for properties created and consumed by the same technology, or for properties set by the presentation layer 204 and then retrieved back by the presentation layer.

With regard to WPF-specific value converters, custom properties are exposed by data wrapper 332 classes (e.g., DataModel\DataSource) as IVsUIObject of the type required and known by the presentation layer, which in this instance is WPF. To convert from these VsUI objects to the values that can be used by data binding, a value converter is required, such as:

<Image Source=“{Binding Path=Icon,
Converter={StaticResource iconValueConverter}}”/>

Using value converters means the code in the wrapper 332 classes doesn't need to change every time a third party package creates a new property type that needs to be converted between different technologies. The code in the data wrapper 332 stays generic and handles the format conversion, and the presentation layer uses value converters to bind the UI elements to the Gel property values.

Requiring use of value converters for every Gel data bound to a WPF UI element would make XAML code harder to write and understand. Accordingly, value converters are not required for built-in data formats. Simple types like int and string, as well as collections and data source properties, can be used directly for data binding, such as:

<TextBlock Text=“{Binding Path=Name}”/>

For built-in property values, the code in the data wrapper 332 classes analyzes the IVsUIObject property value and directly exposes for data bindings the inner data of the built-in property, allowing a system to directly bind an int value, a string value, and so on.

In the Gel framework design, format converters such as data converter objects 802 are registered with a global converter manager service such as a data converter registrar 804. The code in the consumption side analyzes the IVsUIObject format, and if an object has a format that cannot be immediately consumed, an appropriate converter can be obtained from the converter manager service, assuming such converter was previously registered. The IVsUIDataConverterManager interface can be implemented by the SVsUIDataConverters service in msenv.dll. Format converters may need to be implemented in managed code (either C# or CLI) in order to recognize and convert between the Winforms or WPF formats of the value types. In the Gel framework, a format converter cannot be registered if another converter was previously registered for the same type and formats; the first converter will need to be unregistered first if override is intended. Converters that are bidirectional would be registered twice with the converter manager, once for each direction of the conversion.

In the Gel framework, format converters are identified by a GUID. Format converters are defined in a kernel registry in a structure like this:

```
HKLM\SOFTWARE\Microsoft\VisualStudio\X.Y\
    UIDataConverters\
        {Data_Type}\ (e.g. “VsUI.Icon”)
            {Guid}\
                Package= “{Package_Guid}”
```

Registration allows the converter manager to load on demand the necessary converters. Whenever a converter for a type (such as “VsUI.con”) is required, the converter manager looks up the GUIDs of the packages implementing converters for this type and loads those packages. Packages may register all the format converters they implement.

In the Gel framework, a format converter for VsUI.Icon type can access the inner data of an IVsUIObject and “know”/require for instance that the inner data represents an HICON when the format of the object is Win32, and a BitmapSource if the format of the data is WPF. A prudent developer defining a new data type may also define mini interfaces deriving from IVsUIObject and exposing the inner data with functions or getters that are more intuitive to be used. Casting the generic IVsUIObjects to these mini-interfaces can be used for even stronger type safety, such as:

```
  // IDL code
interface IVsUIWin32Icon : IVsUIObject
{
    HRESULT GetHICON( [out] INT_PTR* phIcon );
};
// C# code
public interface IVsUIWPFIcon : IVsUIObject
{
    BitmapSource Image { get; }
};
```

In the Gel framework, a VsUI.Icon in Win32 format is required to implement IVsUIWin321con, and a VsUI.Icon in WPF format is required to implement IVsUIWPFIcon. The Icon converter must still have this “knowledge”/requirement about the implementations of the converted type, but this requirement is more intuitive to express than a requirement on the inner data.

With regard to values lifetime and resource ownership, some native value types require global data that needs to be released in one way or another. For example, objects storing HICONs and HBITMAPs normally call DeleteIcon/DeleteObject to dispose of the GDI resources. Such requirements may impact managed-native interoperability code 212 classes. For example, a converter from System.Drawing.Bitmap to HBITMAP using Bitmap.GetHBitmap( ) to convert from managed to native values should dispose of the returned native handle. A converter from System.Drawing.Image to HICON using Bitmap.GetHIcon( ) should dispose of the returned handle. A converter from System.Drawing.Icon to HICON using Icon.Handle for conversion should not destroy the returned handle. The code using an IVsUIObject for display for an icon should not care whether the object was created by native code or by a converter, and should not care about resource management. In some cases, lifetime management of resources is automatically handled with property values implemented as objects. For instance, a COM object implementing an IVsUIWin32Icon interface stores a private copy of the GDI object handle; the GDI object copy is deleted when the COM object is destroyed. A converter creating instances of such a COM object will only care about deleting or not deleting its local GDI resource, depending on the function it used to obtain that resource.

In the Gel framework, a creator for WPF framework elements is defined as follows:

```
interface IVsUIWpfElement : IUnknown
{
    // Create the associated framework element.
    HRESULT CreateFrameworkElement([out] IUnknown**
ppUnkElement);
};
```

A creator and handler for Win32 (HWND-based) visual elements is defined as follows in the Gel framework:

```
interface IVsUIWin32Element : IUnknown
{
    // Create the element as a child of the given HWND
    HRESULT Create(HWND parent, [out] HWND* pHandle);
    // Destroy the element
    HRESULT Destroy( );
    // Get the HWND
    HRESULT GetHandle([out] HWND* pHandle);
    // Show the element as a modal dialog
    HRESULT ShowModal(HWND parent, [out] int* pDlgResult);
};
```

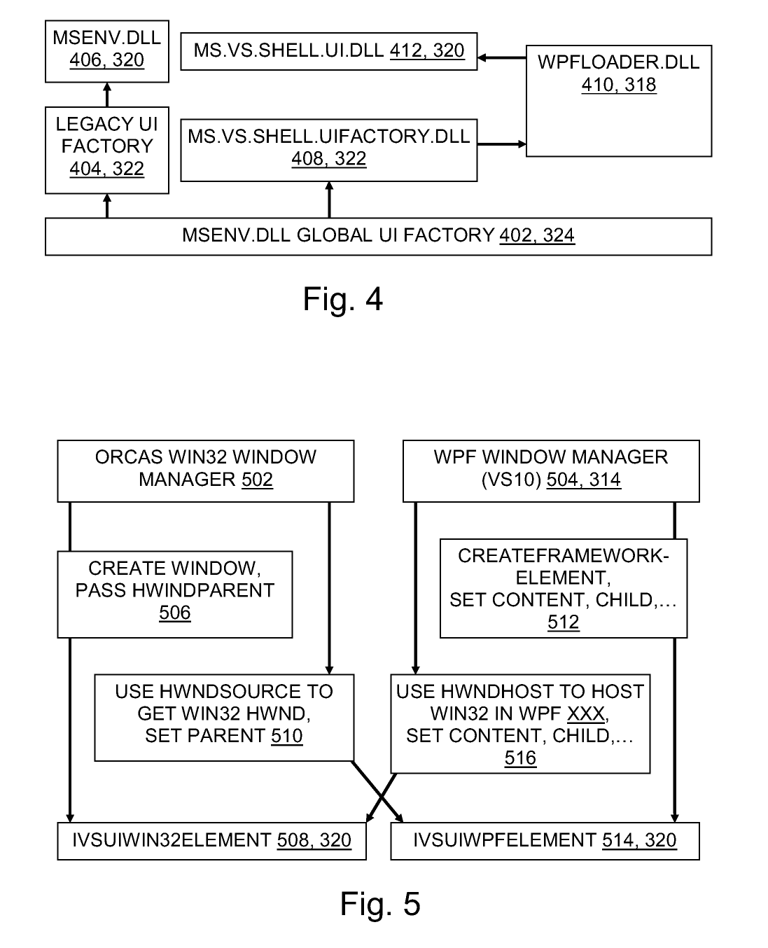

FIG. 4 further illustrates Gel framework UI factories. An MsEnv.dll global UI factory 402 provides an IVsRegisterUIFactories instance including RegisterFactory and CreateUIElement. A legacy UI factory 404 provides an MsEnv.dll UI factory for a Win32-based legacy UI, with an IVsUIFactory instance including CreateUIElement. An MsEnv.dll component 406 includes a Win32 About box and StartPage. An Ms.Vs.Shell.UIFactory.dll 408 provides a UI factory for a WPF Shell UI, with an IVsUIFactory instance including CreateUIElement. A WPFLoader.dll 410 provides a loader with an IVsUIWpfLoader instance including CreateUIElement and CreateUIElementOfType. An Ms.VS.Shell.UI.dll component 412 includes a WPF About box and StartPage. WPF elements are created by the loader 410, in a locally co-creatable manner allowing re-use to load WPF framework elements from a specified managed type or type name and to create IVsUIElements for them, such as:

CreateUIElement(“Microsoft.VisualStudio.Shell.UI”,
“Microsoft.VisualStudio.PlatformUI.AboutBox”)

With regard to Gel UI visual objects, IVsUIElement is presentation-neutral. A window manager calls a GetUIObject( ) method to find presentation-specific compatible elements. A returned object will implement an IVsUIWPFElement for WPF windows and dialogs, an IVsUIWin32Element for Win32 windows and dialogs, and so on. The presentation-specific object includes functions to create and display visuals. The window manager reconciles content and frame technologies, adding hosting pieces if necessary.

FIG. 5 shows a configuration with two window managers, namely, an Orcas window manager 502 and a WPF window manager 504 for Visual Studio® version 10. Orcas is a name used internally at Microsoft to refer to Visual Studio® 2008; Orcas is based on Win32 presentation technology, whereas the WPF window manager is based on WPF. In a communication element 506, the Orcas window manager calls CreateWindow and passes hwndParent as a parameter to an instance of IVsUIWin32Element 508. The Orcas window manager also uses 510 HwndSource to get Win32 window handle (HWND) and sets the parent. In a communication element 512, the WPF window manager calls CreateFrameworkElement and sets content, child, and other values as appropriate for an instance of IVsUIWpfElement 514. The WPF window manager also uses 516 HwndHost to host Win32 in WPF and sets content, child, and other values as appropriate for an instance of IVsUIWin32Element 508.

With regard to hooking the UI with a shell in the Gel framework, dialogs in native code may use GelUtil::ShowModalElement( ), and in managed code may use WindowHelper.ShowModalElement from a Microsoft.VisualStudio.Gel namespace. Legacy Toolwindows may implement IVsWindowPane to work with both Win32 and WPF in a Hwnd-based manner, for example. Code creates the UI element and does the parenting in IVsWindowPane::CreatePane( ), then returns a window handle. Native code may use GelUtil CreateUIElement/GetHwndFromUIElement, and managed code may use WindowHelper.CreateUIElement/GetHwndFromUIElement. New applications may implement IVsUIElementPane, which works only with the WPF window manager, and there are no intervening HWnds for WPF UI elements. Code creates the UI element, calls GetUIObject( ) and returns the visual object from IVsUIElementPane::CreateUIElementPane( ). The window manager then completes display work, for Win32 and WPF UIs. In some cases, the WPF window manager checks first for IVsUIElementPane and then falls back if necessary to IVsWindowPane.

With regard to the Gel framework data model, UI elements 320 have an associated data model. IVsUIDataSource instances (data sources 326) are building blocks in a tree, and have properties which can hold other data sources or data source collections 602, thereby forming a hierarchy. IVsUICollection instances and IVsUIDynamicCollection instances are lists (bags, sets, etc.) of data source items. IVsUIDataSource instances have verbs 330 and properties 328. Verbs are identified by name, e.g., “Help”, and allow the UI to call back into the logic layer 202 code when specified events occur. Properties are also identified by name, e.g., “CurrentLine”. Property values are object(s) implementing IVsUIObject. The arrangement of properties and verbs in a Gel data source is fixed and defines a data source schema.

IVsUIObject property values have a type which is specified in a string, e.g., “VSUI.Int32”. These property values also have a format value which identifies the technology that created them, e.g., Win32, WPF, and so on. Simple property value types that don't need conversion between technologies, such as int and string, have a built-in format. IVsUIObject property values are non-empty VARIANTs, or fallback to other properties. IVsUIDataSource and IVsUICollection can be stored as built-in property values.

FIG. 6 further illustrates data source wrapping in the Gel framework. Gel data sources 326 are presentation-neutral. Data sources 326 are wrapped by wrappers 332 to target a specific presentation technology. For instance, to target WPF, a WPF UI factory 322 will use DataSource and DataSourceCollection wrappers 332, and will set a DataContext 604 property on a FrameworkElement 606 with the wrapper(s) 332. A binding can be directly specified in XAML:

<TextBlock
x:Name=“Licensee”Text=“{BindingMode=OneTime,Path=Licensee}”/ >

FIG. 6 shows an IVsUIDataSource 608 bound to an IVsUIElement 610 allowing communication through get and set operations 612. The IVsUIDataSource 608 is an example of a data source 326. The IVsUIDataSource 608 holds property values as IVsUIObjects; property format depends on the code that created the data source or set the property value. The IVsUIDataSource 608 supports COM technology notifications of the kind generally used in Microsoft Visual Studio® environments. The IVsUIElement 610 uses GetUIObject and CreateFrameworkElement 614 to create the FrameworkElement 606 in WPF. The FrameworkElement 606 sets .DataContext 604 in the DataSource/DataSourceCollection 326/602 within WPF-specific wrappers 332. The wrappers 332 provide reflectable properties, and WPF notifications. Property values can be used directly for bindings. Custom properties are converted to WPF format.

As an example of using custom properties in the Gel framework, a ProductImage property accessible as HICON in Win32 code can be converted to a BitmapSource for use in WPF. If WPF then sets a new BitmapSource value for the property, to be consumed by Win32 code, the property value is converted back to HICON. In view of lifetime management considerations for GDI objects, the conversion is done only if the property value is queried back for consumption.

Gel framework properties are set using a format that is natural for the code setting the value; the setting code may be in the presentation layer 204 or in the logic layer 202. For example, format specifiers include VSDF_WIN32 and VSDF_WPF. A VSDF_BUILTIN format is specified for property values such as int and string which do not require conversion. When a property is consumed, the consuming layer checks whether the property is in a supported format. If it is not, a data converter object 802, such as an IVsUIDataConverter object, can be obtained from the shell, such as a Visual Studio® shell, and used to convert the property value to a format suitable for consumption. For WPF, the Gel framework DataSource wrappers 332 do automatic conversion to VSDF_WPF format. A converter manager or registrar 804 service such as IVsUIDataConverterManager aka IVsUIDataConverterRegistrar keeps track of available converters. Transitive conversions are achieved automatically in the Gel framework, e.g., FormatA→FormatC can be done indirectly via FormatA→FormatB→FormatC.

Implementing a Gel component can be accomplished as follows. Identify a data model, including properties and verbs, and formalize the data model as needed for quality assurance, remembering that special types might require converter objects 802. Mock the data to drive testing. Build the presentation layer 204, using for example a Microsoft Expression Blend environment, a Microsoft Visual Studio Cider environment, or another environment. Create a UI factory 322. Create the real data source. Create the UI element 320 via the UI factory 322. Attach the data source to the UI element, using wrappers 332 for example.

As another example, FIG. 7 shows a block diagram of a personal computer running a Microsoft Windows® operating system as a kernel 124. An extensible platform 310 is an application running on the Windows® operating system. Two applications 120 in the form of extensions 702 are running on the platform 704; these extensions are examples of logic layer(s) 202. Two user interface packages are also present, as examples of presentation layer 204 technologies, namely, a WPF code 314 package and a Microsoft Graphics Device Interface (“GDI”) 706 code package.

FIG. 8 illustrates a system generalized from the Gel framework examples. Examples of most items shown in FIG. 8 are also shown in FIGS. 2 through 7, and are discussed herein under varied but often similar names. For instance, the IVsUIWin32Element 508 shown in FIG. 5 is an example of a UI-element 830, and the FrameworkElement 606 shown in FIG. 6 is an example of a presentation element 824.

In FIG. 8, an extensible platform 806 in the domain-specific layer 202 includes a data model in the form of data-source object(s) 808 and possibly data-source-collection(s) 810. Data-source-factories 812, managed by a data-source-factory-registrar 814, may be present to produce data-source objects 808. Data-converter objects 802, managed by a data-converter-registrar 804, may be present to convert property values of data-source objects 808 between technology-specific formats. Domain-specific data 816 may include data provided for presentation through data-source objects 808, and may include data that is used only within the domain-specific layer 202. Domain-specific data 816 is subject to domain-specific processing 818. Data-source object(s) 808 are wrapped by managed code data source wrappers 820 to facilitate data binding between the domain-specific layer 202 and a user interface 822 built with presentation elements 824 in the presentation layer 204. To further facilitate data binding, UI-element-factories 826 managed by a UI-element-factory-registrar 828 create UI-elements 830 on demand, providing each with a unique ID 832 such as a GUID. Each UI-element 830 includes a UI-element interface 834 and a UI-element object 836 implementing the interface 834. UI-elements are loaded into the presentation layer by a presentation loader 838.

As a facet of databinding, changes in data-source object property value(s) may be communicated to the presentation layer by a change notification 840 such as an event, flag, or signal. Through a collection change notification 840 a subsystem of a logic layer or a presentation layer can communicate changes in a collection to interested parties. Collection changes would usually be effected in the domain-specific layer, so the presentation layer in FIG. 8 listens for these notifications so it can update the UI. In other embodiments, notifications may flow from a presentation layer to a logic layer, or flow in both directions. In the Gel framework, property changes are defined using the following:

```
        // Base interface for all event interfaces
(IVsUIDataSourcePropertyChangeEvents and
IVsUICollectionChangeEvents)
: IUnknown
{
    // Unadvise from and release all references to the given
event source
    HRESULT Disconnect ([in] IVsUISimpleDataSource*
pSource);
};
// Handler for property change event notification
interface IVsUIDataSourcePropertyChangeEvents :
IVsUIEventSink
{
    // Notification that the given property has changed
    // Return code is ignored
    HRESULT OnPropertyChanged( [in] IVsUIDataSource*
pDataSource, [in] LPCOLESTR prop, [in] IVsUIObject *
pVarOld, [in] IVsUIObject * pVarNew );
};
```

In the Gel framework, event notifications on collections are defined using the following:

```
// Interface for event notifications on collections
interface IVsUICollectionChangeEvents : IVsUIEventSink
{
    // Fired after a new item has been added to the
collection
    // nItem is the zero-based index of the newly added item
    // Return code is ignored
    HRESULT OnAfterItemAdded( [in] IVsUIDynamicCollection*
pCollection, [in] UINT nItem );
    // Fired just before an item is to be removed from the
collection
    // nItem is the zero-based index of the soon-to-be
deleted item
    // Return code is ignored
    HRESULT OnBeforeItemRemoved( [in]
IVsUIDynamicCollection* pCollection, [in] UINT nItem );
    // Fired just before an item is updated
    // nItem is the zero-based index of the soon-to-be
modified item
    // Return code is ignored
    HRESULT OnBeforeItemReplaced( [in]
IVsUIDynamicCollection* pCollection, [in] UINT nItem, [in]
IVsUIDataSource *pNewItem );
    // Fired if the entire collection has been cleared or
refereshed
    // Return code is ignored
    HRESULT OnInvalidateAllItems( [in]
IVsUIDynamicCollection* pCollection );
};
```

The UI-element-factory-registrar 828 may serve as a rendezvous point for all UI-element-factories 826 in a subsystem, performing two duties. First, UI-element-factories 826 may announce their availability to the registrar 828. Second, consumers of the subsystem can ask the registrar 828 to create instances of UI-elements 830.

Presentation elements 824 may themselves represent collections, such as a menu with a collection of commands from which the user may pick. The corresponding data-source-collection 810 would, in this example, be a list of commands, each with properties such as (but not limited to) the display text, the pictorial icon, and a Boolean property indicating whether the command is enabled.

With the foregoing in mind, some embodiments provide a computer system 102 having a particular architecture which couples presentation functionality with domain-specific data and data processing functionality. The system 102 includes a logical processor 110 and a memory 112 in operable communication with the logical processor. The memory is configured by a domain-specific layer 202 having domain-specific data 816 and domain-specific data processing 818 functionality. The memory also contains, and is thus configured by, a presentation layer 204 having user interface 822 functionality. In addition, the memory contains a UI-element-factory-registrar 828 for registering at least one UI-element-factory 826 with the domain-specific layer 202, and a UI-element-factory 826 for invoking at least one UI-element 830 on demand to create a UI-element object 836 having a unique identifier 832. A presentation technology-neutral UI-element interface 834 supports creating a UI-element object 836 which is bound to a domain-specific data-source object 808.

In some embodiments, the memory 112 is configured by a data-source-collection 810 for creating a collection of domain-specific data-source objects for property bindings with presentation-elements. In some, the data-source-collection 810 supports a dynamic collection of domain-specific data-source objects, namely, a collection whose membership can change at runtime after the collection has been created.

In some embodiments, the memory 112 is configured by a change notification 840 which is created by the domain-specific data-source object 808 and is accessible to the presentation layer 204.

In some embodiments, the memory 112 is configured by a data-converter object 802 for converting data from a first data format to a second data format. In particular, in some cases one of the formats is used in a native code domain-specific layer 202 and the other of the formats is used in a managed code presentation layer 204. The memory 112 may also be configured by a data-converter-registrar 804 for registering at least one data-converter object with the domain-specific layer and for retrieving a particular data-converter object based on pre-conversion and post-conversion data formats. In some cases, as in the Gel framework, each data format includes a physical type and a logical type. The memory may also contain a data-source-factory 812 for creating a data-converter object for a data-source object having a predefined schema for use with a specific UI-element object 836, and a data-source-factory-registrar 814 for registering a data-source-factory with the domain-specific layer.

Examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

Methods

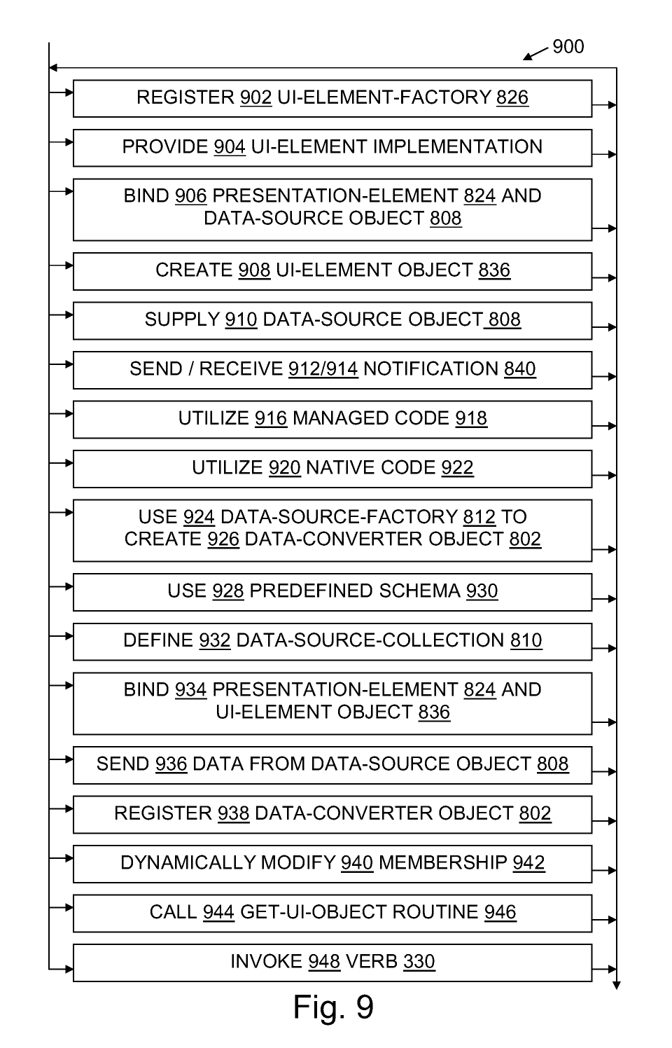

FIG. 9 illustrates some method embodiments in a flowchart 900. In a given embodiment zero or more illustrated steps of a method may be repeated, perhaps with different parameters or data to operate on. Steps in an embodiment may also be done in a different order than the top-to-bottom order that is laid out in FIG. 9. Steps may be performed serially, in a partially overlapping manner, or fully in parallel. The order in which flowchart 900 is traversed to indicate the steps performed during a method may vary from one performance of the method to another performance of the method. The flowchart traversal order may also vary from one method embodiment to another method embodiment. Steps may also be omitted, combined, renamed, regrouped, or otherwise depart from the illustrated flow, provided that the method performed is operable and conforms to at least one claim. A developer is used as an example, but the method steps may be performed by another person and/or by software operating under the control and/or for the benefit of a person.

During a UI-element-factory registering step 902, a developer registers a UI-element-factory 826 with a domain-specific layer 202. Step 902 may be accomplished using a kernel registry or by using a registry which is internal to/maintained solely by a UI-element-factory-registrar 828, for example. Step 902 may be performed on behalf of a particular application 120, such as a native code application in the domain-specific layer 202.

During a providing step 904, a developer provides a UI-element 830 implementation for on-demand creation of a UI-element object 836.

During a data-source object binding step 906, a developer binds a presentation-element 824 to a data-source object 808. Step 906 may be accomplished using a wrapper 820.

During a creating step 908, a developer creates a UI-element object 836. Step 908 and other steps may be accomplished by software and hardware operating at the behest of a developer or another person.

During a supplying step 910, a developer supplies a data-source object 808, e.g., by including source code or linking in a library.

During a notification sending step 912, a system operating at the behest of a developer or another person sends a notification 840 from a data-source object 808 to a presentation layer 204, which receives the notification during a receiving step 914.

During a managed code utilizing step 916, managed code 918 is utilized in one or more of a presentation layer 204, a domain-specific layer 202, and an interoperability code 212. The utilizing step 916 may include one or more other steps of flowchart 900, e.g., by utilizing managed code to bind 906 a presentation-element 824 to a data-source object 808.

During a native code utilizing step 920, native code 922 is utilized in one or more of a presentation layer 204, a domain-specific layer 202, and an interoperability code 212. The utilizing step 920 may include one or more other steps of flowchart 900, e.g., by utilizing native code to supply 910 a data-source object 808.

During a data-source-factory using step 924, a developer uses a data-source-factory 812. In particular, during a creating step 926, a developer uses a data-source-factory 812 to create a data-converter object 802.

During a schema using step 928, a developer uses a predefined schema 930 of a data-source object 808, e.g., to create a data-source object compatible with a specific UI-element 830.

During a defining step 932, a developer defines a data-source-collection 810.

During a UI-element object binding step 934, a developer binds a presentation-element 824 to a UI-element object 836. Step 934 may be accomplished using a wrapper 820.

During a data sending step 936, a system operating at the behest of a developer or another person sends data such as a property 328 from a data-source object 808 to a presentation layer 204.

During a data-converter object registering step 938, a developer registers a data-converter object 802 with a domain-specific layer 202.

During a membership modifying step 940, a system operating at the behest of a developer or another person dynamically modifies membership 942 of a data-source-collection 810.

During a calling step 944 a system operating at the behest of a developer or another person calls a get-UI-object routine 946 to obtain a UI-element object 836 that is compatible with a given presentation layer 204.

During an invoking step 948 a system operating at the behest of a developer or another person invokes a verb 330.

With the foregoing in mind, some embodiments include a method which may be used by a developer to connect a managed code presentation framework 208 with a native code application 120 in a pluggable manner. One such method includes registering 902 at least one UI-element-factory 826 for the native code application. The method also includes providing 904 a UI-element 830 implementation for on-demand creation 908 of a UI-element object 836 to bind 906 a managed code presentation-element 824 to a native code data-source object 808. The UI-element implementation is invocable by the UI-element-factory. The method also includes supplying 910 at least one native code data-source object for the application. In some embodiments, the method further includes the managed code presentation framework asynchronously receiving 914 a notification 840 that the native code data-source object has been updated. The registering step 902 may register a UI-element-factory for the native code application in a Microsoft Windows environment, or a Microsoft Visual Studio® environment, for example. The providing step 904 may support creation of a UI-element object to bind a managed code presentation-element in a Sun Microsystems Java® environment, a Microsoft Windows Forms environment, or a Microsoft Windows Presentation Foundation environment, for example.

In some embodiments, the method includes using 924 a data-source-factory 812 to create a conversion-on-demand data-converter object 802 for a data-source object 808. The data-source object may have a predefined schema 930 for use with a specific UI-element object 836, e.g., a schema 930 specifying a name and at least one data-property object type for the UI-element object.

In some embodiments, the method includes defining 932 a data-source-collection 810 for creating a collection of application data-source objects 808 for property bindings with a collection of presentation-elements 824.

Methods may also include other combinations of steps described herein, in various combinations. Also, steps discussed herein may be performed regardless of whether they are expressly shown in FIG. 9.

Configured Media

Some embodiments include a configured computer-readable storage medium 114, which is an example of a memory 112. Memory 112 may include disks (magnetic, optical, or otherwise), RAM, EEPROMS or other ROMs, and/or other configurable memory. The storage medium which is configured may be in particular a removable storage medium 114 such as a CD, DVD, or flash memory. A general-purpose memory 112, which may be removable or not, and may be volatile or not, can be configured into an embodiment using items such as UI-elements 830, registrars 804, 828, 814, data-converter objects 802, data-source objects 808, and/or data source wrappers 820, in the form of data 118 and instructions 116, read from a removable medium 114 and/or another source such as a network connection, to form a configured medium. The configured memory 112 is capable of causing a computer system to perform method steps for communications 210, bindings, and notifications as disclosed herein. FIGS. 2 through 9 thus help illustrate configured storage media embodiments and method embodiments, as well as system and method embodiments. In particular, any of the method steps illustrated in FIG. 9, or otherwise taught herein, may be used to help configure a storage medium to form a configured medium embodiment.

Some embodiments provide a computer-readable medium 114 configured with data 118 and instructions 116 for causing a computer system 102 to perform a method utilizing a presentation framework 208 with an application 120 in a native code environment. One such method includes registering 902 at least one UI-element-factory 826 with the native code environment, creating 908 at least one UI-element object 836, binding 934 the UI-element object to a presentation-element 824, and sending 936 data from a data-source object 808 in the application 120 toward the UI-element object. The binding step 934 may bind a native Microsoft Windows Win32 graphic user interface to a presentation-element, or it may bind a UI-element object to an HTML presentation-element for a web-based application, for example. In some embodiments, the method includes registering 938 at least one data-converter object 802 with the native code environment for a data type which is not a built-in type, and sending 936 data from the data-source object in the application through the data-converter object toward the UI-element object. In some embodiments, the method includes dynamically modifying 940 membership 942 of a collection of UI-element objects in response to dynamic modification of membership of a collection of data-source objects in the application. In some embodiments, the method includes a presentation framework manager calling 944 a get-UI-object routine to obtain a UI-element object which is compatible with the presentation framework 208.

Conclusion

Although particular embodiments are expressly illustrated and described herein as methods, as configured media, or as systems, it will be appreciated that discussion of one type of embodiment also generally extends to other embodiment types. For instance, the descriptions of methods in connection with FIG. 9 also help describe configured media, and help describe the operation of systems and manufactures like those discussed in connection with FIGS. 2 through 8. It does not follow that limitations from one embodiment are necessarily read into another. In particular, methods are not necessarily limited to the interfaces, data structures, and arrangements presented while discussing systems or manufactures such as configured memories.

Not every item shown in the Figures need be present in every embodiment. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or methodological acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

What is claimed is:

1. A computer system having a particular architecture which couples presentation functionality with domain-specific data and data processing functionality, the system comprising:
a logical processor;
a memory in operable communication with the logical processor, the memory configured by:
a domain-specific layer having domain-specific data and domain-specific data processing functionality;
a presentation layer having user interface functionality;
a UI-element-factory-registrar for registering at least one UI-element-factory with the domain-specific layer;
a UI-element-factory for invoking at least one UI-element on demand to create a UI-element object having a unique identifier; and
a presentation technology-neutral UI-element interface for creating a UI-element object which is bound to a domain-specific data-source object.

2. The system of claim 1, further comprising a data-source-collection for creating a collection of domain-specific data-source objects for property bindings with presentation-elements.

3. The system of claim 2, wherein the data-source-collection supports a dynamic collection of domain-specific data-source objects, namely, a collection whose membership can change at runtime after the collection has been created.

4. The system of claim 1, further comprising a change notification created by the domain-specific data-source object and accessible to the presentation layer.

5. The system of claim 1, further comprising a data-converter object for converting data from a first data format to a second data format, one of the formats being used in a native code domain-specific layer and the other of the formats being used in a managed code presentation layer.

6. The system of claim 1, further comprising a data-converter-registrar for registering at least one data-converter object with the domain-specific layer and for retrieving a particular data-converter object based on pre-conversion and post-conversion data formats.

7. The system of claim 6, wherein each data format includes a physical type and a logical type.

8. The system of claim 1, further comprising a data-source-factory for creating a data-converter object for a data-source object having a predefined schema for use with at least one specific UI-element object.

9. The system of claim 1, further comprising a data-source-factory-registrar for registering at least one data-source-factory with the domain-specific layer.

10. A method which may be used by a developer to connect a managed code presentation framework with a native code application in a pluggable manner, the method comprising the steps of:
registering at least one UI-element-factory for the native code application;
providing a UI-element implementation for on-demand creation of a UI-element object to bind a managed code presentation-element to a native code data-source object, the UI-element implementation invocable by the UI-element-factory; and
supplying at least one native code data-source object for the application.

11. The method of claim 10, further comprising the managed code presentation framework asynchronously receiving a notification that the native code data-source object has been updated.

12. The method of claim 10, wherein at least one of the following occurs:
the registering step registers at least one UI-element-factory for the native code application in a Microsoft Windows environment;
the registering step registers at least one UI-element-factory for the native code application in a Microsoft Visual Studio environment;
the providing step provides a UI-element implementation for on-demand creation of a UI-element object to bind a managed code presentation-element in a Sun Microsystems Java environment to a native code data-source object;
the providing step provides a UI-element implementation for on-demand creation of a UI-element object to bind a managed code presentation-element in a Microsoft Windows Forms environment to a native code data-source object;
the providing step provides a UI-element implementation for on-demand creation of a UI-element object to bind a managed code presentation-element in a Microsoft Windows Presentation Foundation environment to a native code data-source object.

13. The method of claim 10, further comprising using a data-source-factory to create a conversion-on-demand data-converter object for a data-source object.

14. The method of claim 13, wherein the data-source object has a predefined schema for use with a specific UI-element object, the schema specifying a name and at least one data-property object type for the UI-element object.

15. The method of claim 10, further comprising defining a data-source-collection for creating a collection of application data-source objects for property bindings with a collection of presentation-elements.

16. A computer-readable medium configured with data and instructions for causing a computer system to perform a method utilizing a presentation framework with an application in a native code environment, the method comprising the steps of:
registering at least one UI-element-factory with the native code environment;
creating at least one UI-element object;
binding the at least one UI-element object to a presentation-element; and
sending data from a data-source object in the application toward the UI-element object.

17. The configured medium of claim 16, wherein the method further comprises registering at least one data-converter object with the native code environment for a data type which is not a built-in type, and sending data from the data-source object in the application through the data-converter object toward the UI-element object.

18. The configured medium of claim 16, wherein the method comprises at least one of the following:
binding at least one UI-element object for a native Microsoft Windows Win32 graphic user interface to a presentation-element;
binding at least one UI-element object to an HTML presentation-element for a web-based application.

19. The configured medium of claim 16, wherein the method further comprises dynamically modifying membership of a collection of UI-element objects in response to dynamic modification of membership of a collection of data-source objects in the application.

20. The configured medium of claim 16, wherein the method further comprises a presentation framework manager calling a get-UI-object routine to obtain a UI-element object which is compatible with the presentation framework.
